(19) United States
(12) Patent Application Publication
(10) Pub. No.: US 2020/0040761 A1
(43) Pub. Date: Feb. 6, 2020

(54) VARIABLE-GEOMETRY TURBOCHARGER

(71) Applicants: Hyundai Motor Company, Seoul (KR); Kia Motors Corporation, Seoul (KR)

(72) Inventor: Seok Beom JIN, Seongnam-si (KR)

(73) Assignees: Hyundai Motor Company, Seoul (KR); Kia Motors Corporation, Seoul (KR)

(21) Appl. No.: 16/169,099

(22) Filed: Oct. 24, 2018

(30) Foreign Application Priority Data
Jul. 31, 2018 (KR) 10-2018-0089343

(51) Int. Cl. F01D 17/16; F02B 37/24; F02C 6/12

(52) U.S. Cl. CPC F01D 17/165; F05B 2220/40; F02C 6/12; F02B 37/24

(57) ABSTRACT

A variable-geometry turbocharger may include an internal ring provided in a turbine housing in a shape enclosing a turbine wheel and having fixed vanes provided in a circumferential direction thereof; and an external ring provided in a shape enclosing the internal ring and having rotary vanes rotatably provided in a circumferential direction thereof, the rotary vanes being paired with the fixed vanes in a state in which the rotary vanes remain in normal contact with the fixed vanes, wherein the internal ring and the external ring are rotated relative to each other by a predetermined angle, and according to the relative rotation, the rotary vanes are rotated and relative positions of the fixed vanes paired with the rotary vanes are changed, which causes a total length of each vane pair including a rotary vane and a fixed vane to be changed such

### CROSS REFERENCE TO RELATED APPLICATION

The present application claims priority to Korean Patent Application No. 10-2018-0089343, filed Jul. 31, 2018, the entire contents of which is incorporated herein for all purposes by this reference.

### BACKGROUND OF THE INVENTION

### Field of the Invention

The present invention relates to a variable-geometry turbocharger that eliminates variation in a vane-opening amount by improving and simplifying a vane operation mechanism.

### Description of Related Art

A turbocharger is an apparatus provided to rotate an exhaust turbine with the energy of the exhaust gas such that a compressor directly connected to the exhaust turbine wheel compresses air and supplies the compressed air to the engine to increase the output of the engine.

That is, when the exhaust gas rotates the turbine wheel, the compressor compresses the air flowing through an air cleaner while being rotated by the rotational force of the turbine wheel, and the compressed air is supplied to each cylinder of the engine, increasing the output of the engine.

Meanwhile, a Variable-Geometry Turbocharger (VGT) is a turbocharger that controls an intake air amount by changing the angle of a variable control vane and controls a supercharging pressure by controlling the intake air amount according to the engine speed and power.

For example, one end portion of each of a plurality of vane arms is connected along the circumference of a circular unison ring, a rotation shaft is provided at the other end portion of each vane arm, and swing vanes are rotatably connected to the rotation shaft.

That is, when the unison ring is rotated by the operating force of an actuator, the vane arms connected to the unison ring rotate about the rotation shaft, and the swing vanes connected to the rotation shaft simultaneously rotate by a desired angle.

Accordingly, in the low-speed region, by reducing the cross-sectional area of the flow path into which the exhaust gas flows by changing the angle of the swing vanes, the flow speed of the air is increased, whereby the rotation speed of the turbine is increased and the supercharging pressure is increased.

In the high-speed region, by increasing the cross-sectional area of the exhaust gas flow path by changing the angle of the swing vanes, the air amount is increased, whereby it is possible to secure the supercharging pressure required for engine operation.

However, since the VGT has many moving and sliding components necessary for adjusting the air flow rate, there is a problem in that variation in a vane-opening amount (i.e. A difference between the actual value and the command value) may occur due to abrasive wear of the sliding components.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a variable-geometry turbocharger in which variation in a vane-opening amount is eliminated by improving and simplifying a vane-operating mechanism.

To achieve the aspect described above, the configuration of the present invention may include: an internal ring provided in a turbine housing in a shape enclosing a turbine wheel and having fixed vanes provided in a circumferential direction thereof; and an external ring provided in a shape enclosing the internal ring and having rotary vanes rotatably provided in a circumferential direction thereof, the rotary vanes being paired with the fixed vanes in the state in which the rotary vanes remain in normal contact with the fixed vanes. The internal ring and the external ring may be rotated relative to each other by a predetermined angle, and according to the relative rotation, the rotary vanes may be rotated and the relative positions of the fixed vanes paired with the rotary vanes are changed, which causes the total length of each vane pair including a rotary vane and a fixed vane to be changed such that a sectional area of a flow path formed between adjacent vane pairs varies.

The internal ring may be rotatably provided coaxially with the turbine wheel, the fixed vanes may be fixedly mounted on one side of the internal ring at regular intervals, the external ring may be fixed to the internal surface of the turbine housing, the rotary vanes may be rotatably mounted on one side of the external ring around respective rotation shafts at an intermediate stage, the rotary vanes being provided at positions corresponding to the fixed vanes, and the internal surfaces of the rotary vanes may come into contact with external surfaces of the fixed vanes.

One end portion of each of the fixed vanes may be positioned closer to the external circumferential surface of the internal ring than the other end portion thereof, being formed in a shape inclined to one side, one end portion of each of the rotary vanes may be positioned closer to an external circumferential surface of the external ring than the other end portion thereof, being formed in a shape inclined to the same side as each of the fixed vanes, a fixed contact surface may be formed on a portion of an external surface of each of the fixed vanes, which is continuous from one end portion of each of the fixed vane, and a rotary contact surface may be formed on a portion of an internal surface of each of the rotary vanes, which is continuous from the remaining end portion of each of the rotary vanes such that the rotary contact surface may be provided to be in contact with the fixed contact surface.

The internal ring may have a stopper formed in the external circumferential surface thereof, and the external ring may have a long guide groove formed in the internal circumferential surface thereof to correspond to the stopper such that a rotation angle of the internal ring may be regulated to be the same angle as the rotation angle within which the stopper is moved along the guide groove.

The maximum rotation angle of the internal ring may be determined within a rotation angle within which the fixed vanes do not get out of a state in which the fixed vanes are in contact with the rotary vanes.

The configuration of the present invention may further include a return spring configured to provide an elastic force in a direction in which the rotary vanes are in normal contact with the fixed vanes.

Through the means for solving the problem described above, according to an exemplary embodiment of the present invention, when the internal ring is rotated according to the engine operation condition, the length of each vane pair is changed while a fixed vane paired with a rotary vane is rotated, which causes the inflow rate of exhaust gas to be variably controlled.

Therefore, it is possible to reduce variation in a vane-opening amount by eliminating moving and sliding components required for controlling the inflow amount of exhaust gas and improving and simplifying an inflow rate adjusting mechanism in comparison with the existing swing vane type. Furthermore, by implementing a two-stage vane structure in which the fixed vanes and the rotary vanes are paired with each other, it is possible to improve the aerodynamic characteristic of exhaust gas by optimizing the profile of the vanes.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a configuration in which an internal ring and an external ring are provided inside a turbine housing according to an exemplary embodiment of the present invention;

FIG. 2 is a view illustrating the internal ring and the external ring of FIG. 1, which are viewed from the rear side;

FIG. 3 is a view illustrating the internal ring and the external ring of the present invention in a separated state;

FIG. 4 is a view for explaining a configuration for regulating the rotation angle of the internal ring according to an exemplary embodiment of the present invention; and

FIG. 5 and FIG. 6 are views each illustrating an operation state in which an exhaust gas inflow rate is variable according to an engine operation condition.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On the other hand, the invention(s) is/are intended to cover not only the exemplary embodiments of the present invention, but also various alternatives, modifications, equivalents and other embodiments, which may be included within the spirit and scope of the invention as defined by the appended claims.

Hereinafter, embodiments of the present invention will be described in detail with reference to the accompanying drawings.

A VGT of the present invention has a two-stage vane structure, and may include an internal ring 10 provided with fixed vanes 11 and an external ring 20 provided with rotary vanes 21.

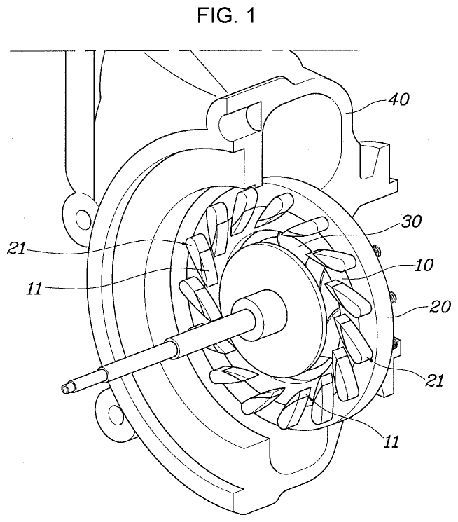

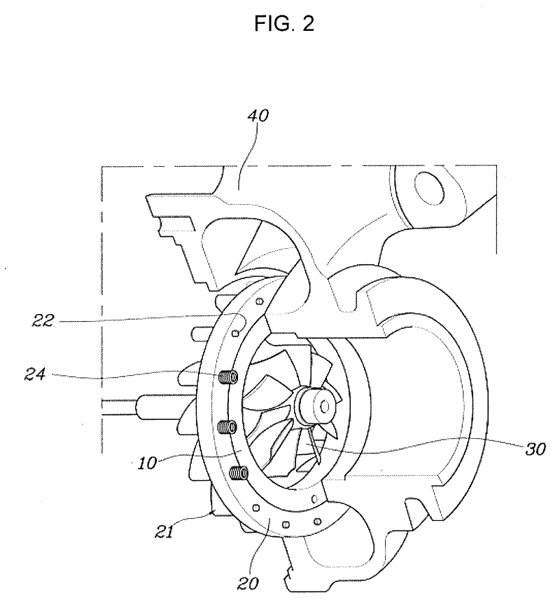

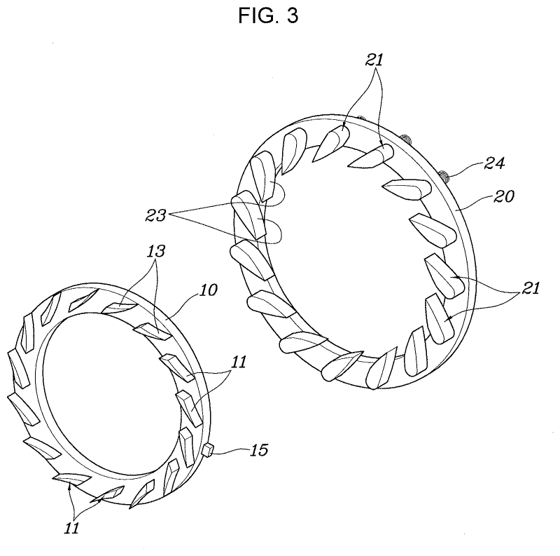

The present invention is described in detail with reference to FIG. 1, FIG. 2, and FIG. 3. First, the internal ring 10 is formed in a circular annular shape and is provided in a shape enclosing a turbine wheel 30 within a turbine housing 40. The fixed vanes 11 are fixedly provided along the circumference of the internal ring 10.

The external ring 20 is formed in a circular annular shape and is provided in a shape enclosing the internal ring 10. The rotary vanes 21 are rotatably provided in the circumferential direction of the external ring 20. The rotary vanes 21 are paired with the fixed vanes 11 in the state in which the rotary vanes 21 remain in normal contact with the fixed vanes 11.

At the instant time, the internal ring 10 and the external ring 20 are rotated relative to each other by a predetermined angle, and the rotary vane 21 is rotated according to the relative rotation operation, and the relative positions of the fixed vanes 11 paired with the rotary vanes 21 vary. As a result, the overall length formed by a vane pair including a rotary vane 21 and a fixed vane 11 in the longitudinal direction formed by the vane pair flexibly varies, whereby the sectional area of a flow path formed between adjacent vane pairs becomes variable.

That is, the fixed vanes 11 provided in the internal ring 10 and the rotary vanes 21 provided in the external ring 20 are paired to form a two-stage vane structure. When the internal ring 10 is rotated relative to the external ring 20 according to an engine operation condition, the fixed vanes 11 paired with the rotary vanes 21 are rotated relative thereto, so that the total length of each vane pair becomes longer or shorter.

Therefore, the cross-sectional area of the flow path formed between adjacent vane pairs is increased or decreased, making it possible to control the inflow rate of the exhaust gas.

Furthermore, referring to FIG. 1 and FIG. 2, in an exemplary embodiment of the present invention, the internal ring 10 is provided coaxially with the turbine wheel 30 to be rotatable, and the fixed vanes 11 are fixedly mounted on one side of the internal ring 10 at regular intervals. Here, the internal ring 10 may be provided with rotational force by an actuator or some other rotational-force-providing means.

Furthermore, the external ring 20 is fixed to the internal surface of the turbine housing 40 and the rotary vanes 21 are mounted on one side of the external ring 20 to be rotatable about respective rotation shafts 22 in an intermediate stage. At the instant time, the rotary vanes 21 are provided at positions corresponding to the fixed vanes 11 such that one fixed vane 11 and one rotary vane 21 form a vane pair.

Furthermore, the internal surfaces of the rotary vanes 21 are in normal contact with the external surfaces of the fixed vanes 11.

That is, when the internal ring 10 is rotated, the fixed vanes 11 provided in the internal ring 10 are rotated with the rotary vanes 21, which are paired with the fixed vanes 11, while sliding and pushing the rotary vanes 21. Thus, the rotary vanes 21 are rotated about respective rotation shafts 22. Therefore, the length of each vane pair is expanded and contracted, so that the cross-sectional area of the flow path between vane pairs may be varied.

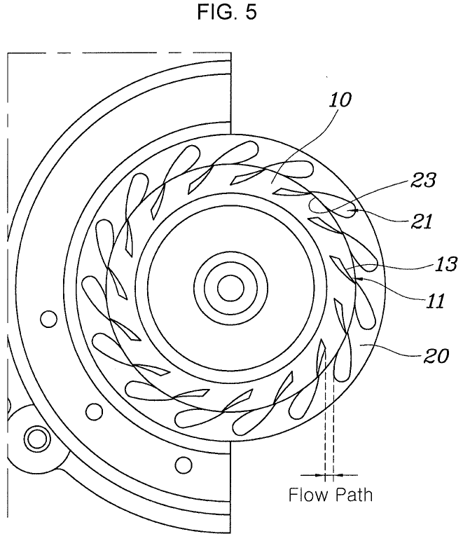

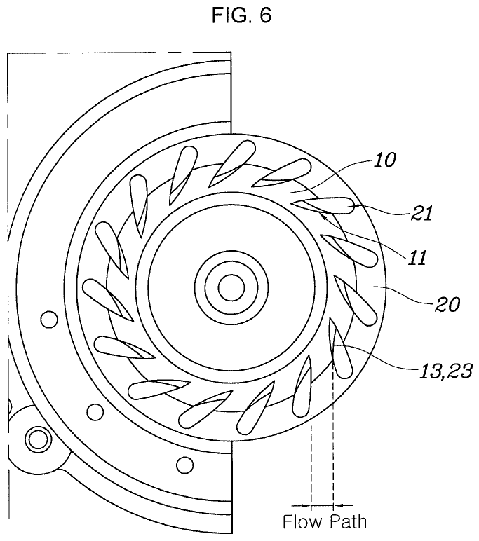

A structure in which the fixed vanes 11 and the rotary vanes 21 are paired will be described in more detail with reference to FIG. 5 and FIG. 6. One end portion of each fixed vane 11 is located closer to the external circumferential surface of the internal ring 10 than the other end portion of the fixed vane 11, whereby the fixed vane 21 is formed in an inclined shape.

Furthermore, one end portion of each rotary vane 21 is located closer to the external circumferential surface of the external ring 20 than the other end portion of the corresponding fixed vane 11, whereby the rotary vane is formed in a shape inclined in the same direction as the fixed vane 11.

Furthermore, a fixed contact surface 13 is formed on a portion of the external surface of the fixed vane 11 that extends from one end portion of the fixed vane 11, and a rotary contact surface 23 is formed on a portion of the internal surface of the rotary vane 21, which is continued from the other end portion of the rotary vane 21. Thus, the fixed vane 11 slides in the state in which the rotary contact surface 23 is in contact with the fixed contact surface 13.

That is, since the fixed vanes 11 are located inside the rotary vanes 21 with respect to the radial direction thereof, the fixed contact surfaces 13 formed on the external side of the fixed vanes 11 and the rotary contact surfaces 23 formed on the internal side of the rotary vanes 21 are paired with each other in the state of being in contact with each other.

Therefore, when the fixed vanes 11 are rotated according to the rotation of the internal ring 10, the fixed contact surfaces 13 of the fixed vanes 11 are moved while sliding on the rotating contact surfaces 23 of the rotating vanes 21.

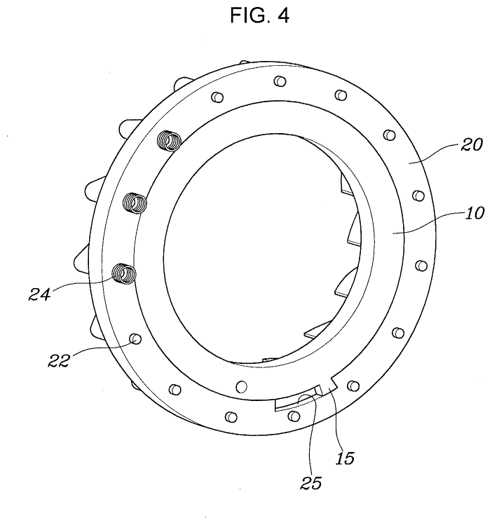

Meanwhile, as illustrated in FIG. 4, the present invention has a configuration in which a stopper 15 protrudes from the external circumferential surface of the internal ring 10, and a long guide recess 25 corresponding to the stopper 15 is formed in the internal circumferential surface of the external ring 20 such that the rotation angle of the internal ring 10 is regulated to be the same as the rotation angle at which the stopper 15 is moved along the guide recess 25.

At the instant time, the maximum rotation angle of the internal ring 10 is determined within a rotation angle within which the fixed vanes 11 remain in the state in which the fixed vanes 11 are in contact with the rotary vanes 21.

That is, when the fixed contact surfaces 13 of the fixed vanes 11 slide on the rotary contact surfaces 23 of the rotary vanes 21 due to the rotation of the internal ring 10, the maximum rotation angle of the internal ring 10 is regulated by the rotation displacement regulation of the stopper 15 with respect to the guide recess 25, and thus the fixed contact surfaces 13 are not separated from the rotary contact surfaces 23.

Furthermore, in an exemplary embodiment of the present invention, the return springs 24 may be provided to provide the elastic force in a direction in which the rotary vanes 21 are in normal contact with the fixed vanes 11.

For example, each return spring 24 may be a torsion spring, which is disposed on the rotation shaft 22 of one rotary vane 21. One end portion of the return spring 24 is fixed to the rotation shaft 22 and the other end portion thereof is fixed to the external ring 20 such that the rotary vane 21 may be configured to provide an elastic force in a direction in which the rotary vane 21 is in normal contact with the fixed vane 11 which is paired therewith.

Hereinafter, the operation of adjusting the inflow rate of the exhaust gas through the operation of the vane according to an exemplary embodiment of the present invention will be described.

First, FIG. 5 exemplifies an operating state in a low-speed region according to the engine operation condition. When the internal ring 10 is rotated in the counterclockwise direction with reference to the drawing, the fixed vanes 10 provided in the internal ring 10 are rotated therewith. The fixed contact surfaces 13 formed on the fixed vanes 11 are pushed and slid in a direction away from the rotary contact surfaces 23 formed on the rotary vanes 21, and each rotary vane 21 rotates in the clockwise direction about the rotation shaft 22 thereof.

As a result, not only is the cross-sectional area of the flow path formed between two adjacent rotary vanes 21 relatively narrowed, but a fixed vane 11 is also positioned between the two rotary vanes 21, whereby the cross-sectional area of the flow path between adjacent vane pairs is reduced, so that the flow speed of the exhaust gas may be increased.

FIG. 6 exemplifies an operating state in a high-speed region according to the engine operation condition. When the internal ring 10 is rotated in the clockwise direction thereof, the fixed contact surfaces 13 of the fixed vanes 11 are slid in the direction in which the fixed contact surfaces 13 come into planar contact with the rotary contact surfaces 23 of the rotary vanes 21. Thus, each rotary vane 21 is rotated in the counterclockwise direction about the rotation shaft 22 thereof.

As a result, not only does the cross-sectional area of the flow path formed between two adjacent rotary vanes 21 become relatively wide, but the fixed vanes 11 also overlap the rotary vanes 21 paired therewith. Thus, the cross-sectional area of the flow path between adjacent vane pairs is increased, so that the flow rate of the exhaust gas may be increased.

As described above, according to an exemplary embodiment of the present invention, when the internal ring 10 is rotated according to the engine operation condition, the length of each vane pair is changed while a fixed vane 11 paired with a rotary vane 21 is rotated, which causes the inflow rate of exhaust gas to be variably controlled. Therefore, it is possible to reduce variation in a vane-opening amount by eliminating moving and sliding components required for controlling the inflow amount of exhaust gas and improving and simplifying an inflow rate adjusting mechanism in comparison with the existing swing vane type. Furthermore, by implementing a two-stage vane structure in which the fixed vanes 11 and the rotary vanes 21 are paired with each other, it is possible to improve the aerodynamic characteristic of exhaust gas by optimizing the profile of the vanes.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable-geometry turbocharger comprising:
an internal ring provided in a turbine housing, enclosing a turbine wheel, and having fixed vanes fixedly provided in a circumferential direction of the internal ring; and
an external ring enclosing the internal ring and having rotary vanes rotatably provided in a circumferential direction of the external ring, wherein the rotary vanes are paired with the fixed vanes in a state in which the rotary vanes continuously remain in contact with the fixed vanes,
wherein the internal ring and the external ring are rotated relative to each other in a predetermined angle, and
wherein according to the relative rotation between the internal ring and the external ring, the rotary vanes are rotated and relative positions of the fixed vanes with respect to the rotary vanes paired with the fixed vanes are changed, which causes a total length of each vane pair including a rotary vane and a fixed vane to be changed such that a sectional area of a flow path formed between adjacent vane pairs varies.

2. The variable-geometry turbocharger of claim 1,
wherein the internal ring is rotatably provided coaxially with the turbine wheel,
wherein the fixed vanes are fixedly mounted on a side of the internal ring at predetermined intervals,
wherein the external ring is fixed to an internal surface of the turbine housing,
wherein the rotary vanes are rotatably mounted on a side of the external ring around respective rotation shafts, the rotary vanes being provided at positions corresponding to the fixed vanes, and
wherein internal surfaces of the rotary vanes continuously come into contact with external surfaces of the fixed vanes.

3. The variable-geometry turbocharger of claim 2,
wherein an end portion of each of the fixed vanes is disposed closer to an external circumferential surface of the internal ring than a remaining end portion thereof, being formed in a shape inclined to one side thereof,
wherein an end portion of each of the rotary vanes is disposed closer to an external circumferential surface of the external ring than a remaining end portion thereof, being formed in a shape inclined to a same side as each of the fixed vanes,
wherein a fixed contact surface is formed on a portion of an external surface of each of the fixed vanes, which is continuous from an end portion of each of the fixed vane, and
wherein a rotary contact surface is formed on a portion of an internal surface of each of the rotary vanes, which is continuous from the remaining end portion of each of the rotary vanes such that the rotary contact surface is provided to be in contact with the fixed contact surface.

4. The variable-geometry turbocharger of claim 2,
wherein the internal ring has a stopper formed in an external circumferential surface thereof, and
wherein the external ring has a guide groove formed in an internal circumferential surface of the external ring and the stopper of the internal ring is mounted in the guide groove of the external ring such that a rotation angle of the internal ring is regulated to be a same angle as a rotation angle within which the stopper is moved along the guide groove.

5. The variable-geometry turbocharger of claim 4, wherein a maximum rotation angle of the internal ring is determined within a rotation angle within which the fixed vanes in which the fixed vanes are in contact with the rotary vanes.

6. The variable-geometry turbocharger of claim 1, further including
a return spring providing an elastic force in a direction in which the rotary vanes are in the contact with the fixed vanes.
